(19) United States
(12) Patent Application Publication
(10) Pub. No.: US 2008/0126597 A1
(43) Pub. Date: May 29, 2008

(54) Alternative Local Card, Central Management Module and System Management Architecture For Multi-Mainboard System

(75) Inventor: Tomori Hirai, Fremont, CA (US)

Correspondence Address: APEX JURIS, PLLC;TRACY M HEIMS, LAKE CITY CENTER, SUITE 410, 12360 LAKE CITY WAY NORTHEAST, SEATTLE, WA, 98125, US

(73) Assignee: TYAN COMPUTER CORPORATION, Taipei (TW)

(21) Appl. No.: 11/622,236

(22) Filed: Jan. 11, 2007

Related U.S. Application Data
(60) Provisional application No. 60/822,406, filed on Aug. 15, 2006.

(51) Int. Cl. G06F 3/00

(52) U.S. Cl. 710/19

(57) ABSTRACT

A system management architecture is provided to monitor and control a multi-mainboard system with plural system mainboards. The system management architecture includes a local card for alternatively replacing a BMC (Baseboard Management Controller)-based management card on the system mainboard. The local card mainly includes a GPIO (General Purpose Input/Output) device and a basic logic. A central management module is also used in the system management architecture to monitor and control the system mainboard through a management bus and the management or local card. The local card monitors status signals on the system mainboard according to the command signals from the central management module, and additionally, provides customized monitoring capability. Accordingly, the local card facilitates the implementation flexibility for the system management architecture and reduces the cost and maintenance supports required by numerous BMC-based management cards.

### BACKGROUND OF THE INVENTION

1. Field of Invention

The present invention relates to system management architecture in a computer system, and more particularly, to a system management architecture for a multi-mainboard system, and a central management module and alternative local card(s) thereof.

2. Related Art

A multi-mainboard system with numbers of mainboards (or mother boards) configured in a single rack or chassis is the typical physical architecture for various computing systems like clustering system, SMP (Symmetric Multi-Processing) system, storage sever, network appliance and etc. In such system every mainboard may be considered as an independent computer. To manage every mainboard in the system, a local BMC (Baseboard Management Controller) is used thereon for local management or board-level management. Another management hierarchy in the system, if any, will be a central management module, which manages all the mainboards through the local BMCs and also controls some system-level or chassis-level functions.

FIG. 1 shows a typical implementation of a multi-mainboard system in the prior art. A clustering system 100 includes five mainboards operating as one head node 110 and four compute nodes 120. Each of the compute nodes 120 has a dedicated local BMC 121 for monitoring and controlling its component performance and plural operation statuses, such as temperatures, voltages, fan speeds, power supply states, bus errors, system physical security, etc. Generally, the monitored statuses are collected by the local BMC 121 and sent through a management bus 130 to a central management module 111 configured on the head node 110. In a certain implementation, the central management module 111 includes a central BMC (not shown) to manage all the local BMCs 121.

Except the compute nodes 121, some system-level function modules such as power supply module 140, system fan module 150 and other function module(s) 160 are also managed by the central management module 111. Each of the function modules may include a controller connecting to the management bus 130 for management purposes. For example, the power supply module 140 has a power supply controller 141 and several power supply units (PSUs) 142 managed directly by the central management module 111.

However, in view of compact design and economic issue, to implement a dedicated local BMC on each of the mainboards seems not to be always necessary for every mainboard in the multi-mainboard system; especially for low-end systems. The system management architecture with full local BMCs for all system mainboards is costly and lack of customization flexibility.

### SUMMARY OF THE INVENTION

The problems noted above are solved in large part by system management architecture and its local card and central management module according to the present invention. Accordingly, the local card facilitates the implementation flexibility for the system management architecture and reduces the cost and maintenance supports required by numerous BMC-based management cards.

In an embodiment of the present invention, a system management architecture is disclosed for monitoring and controlling at least one system mainboard. The system management architecture includes a management bus, a central management module, and a local card or a BMC-based management card. The central management module sends plural command signals to the system mainboard through the management bus, and receives plural status signals from the system mainboard through the management bus. The local card or the management card is alternatively configured on the system mainboard, each having a same management interface for connecting with the system mainboard and the management bus.

In another embodiment of the present invention, a local card is provided for alternatively replacing a BMC-based management card to be configured on a system mainboard through a management interface and controlled/monitored through a management bus; wherein the local card includes a GPIO device and a basic logic. The GPIO device provides plural GPIO pins for receiving/sending the command/status signals between the basic logic and the management bus through the management interface. The basic logic processes the command/status signals and sends between the GPIO device and the system mainboard through the management interface.

In another embodiment of the present invention, the local card further includes a management path for connecting with a local management bus of the system mainboard and the management bus through the management interface, thereby directly controlling at least one monitored device on the system mainboard.

In another embodiment of the present invention, the basic logic of the local card includes a command decoder, status/event monitor(s), control circuit(s) and a multiplexer. The command decoder decodes plural command signals and a selection signal from the management bus. The status monitor or event monitor receives plural status/event signals from the system mainboard through the management interface. The control circuit generates control signal(s) and control-status signal(s) according to the decoded command signal; wherein the control signals is sent to the system mainboard. The multiplexer receives the control-status signal and the status signals and selectively sends to the GPIO device according to the decoded selection signal.

In another embodiment of the present invention, a central management module is provided for sending plural command signals to a system mainboard through a management bus, and for receiving plural status/event signals from the system mainboard through the management bus; wherein the central management module includes a BMC-based management card for sending the command signals and receiving the status signals; wherein the central management module further includes a central GPIO device and a central logic. The central GPIO device provides a plurality of GPIO pins for receiving/sending the command/status signals between the management card and the central logic. The central logic processes the command/status signals and sends between the central GPIO device and the management bus.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 is an explanatory diagram of a typical system management architecture in the prior art.

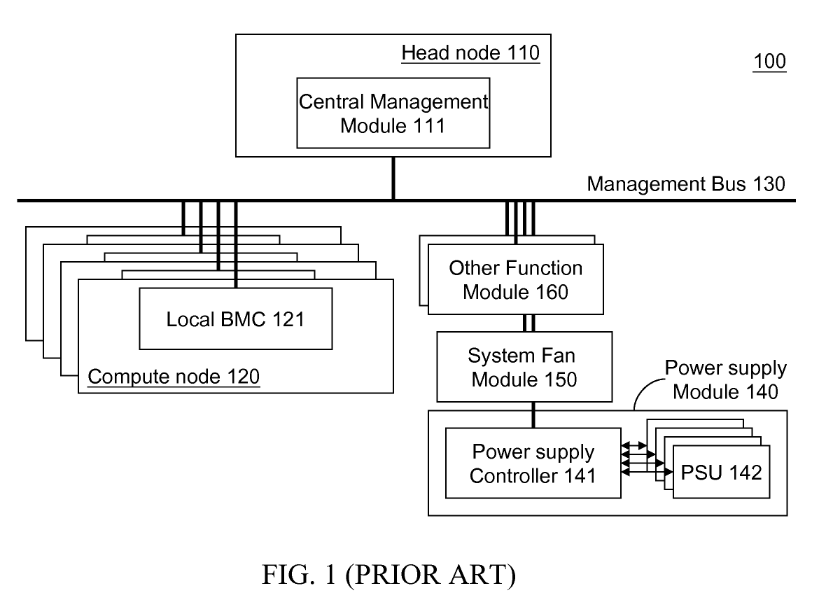

FIG. 2 shows an embodiment of a system management architecture according to the present invention.

FIG. 3A shows another embodiment of the system management architecture according to the present invention.

FIG. 3B is an explanatory diagram of a local card according to the present invention, showing a portion on the local card related to a management path.

FIG. 3C is a detailed explanatory diagram for another embodiment of the local card according to the present invention.

FIG. 4A shows another embodiment of the system management architecture according to the present invention.

FIG. 4B is a detailed explanatory diagram for an embodiment of a central management module according to the present invention.

### DETAILED DESCRIPTION OF THE INVENTION

Basically, the present invention disclosed by the following embodiments provides a specific system management architecture, which mainly includes “local card” and “management card” as alternatives that are compatible with the same management interface on each system mainboard. One or more of the management cards on the system mainboards may be replaced by the alternative local card(s) to provide minimum management functions and some customization capabilities. In an optimum embodiment, using a BMC (Baseboard Management Controller)-based central management module and the local card(s) are enough to remotely manage a whole multi-mainboard system. Alternatively, some management card(s) may still remain on some of the system mainboards for full function management. In the present invention, a BMC-based device means the device has a BMC configured thereon; no matter it is configured on-board or on-card.

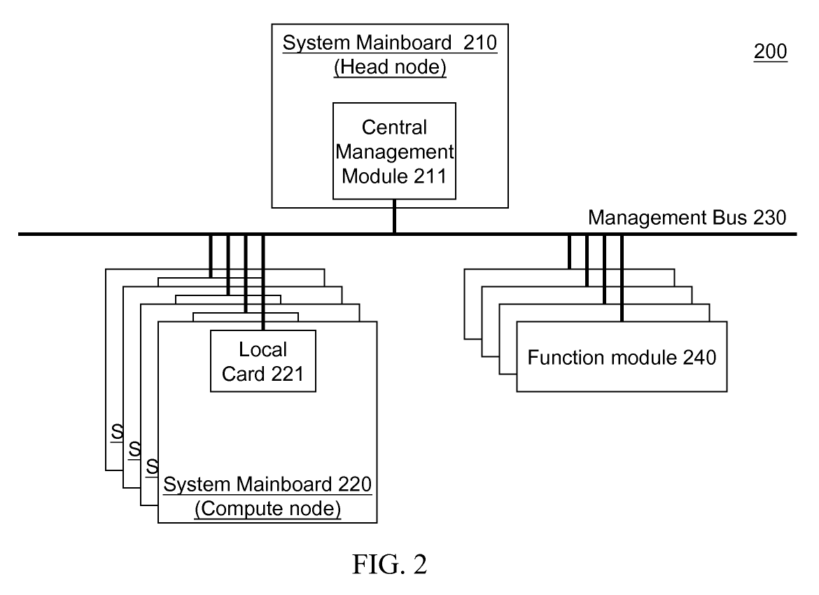

Please refer to FIG. 2. In a multi-mainboard system 200 such as blade system, clustering system or Symmetric Multi-Processing (SMP) system, a system management architecture mainly includes a central management module 211 and plural local cards 221 configured respectively on plural system mainboards 210, 220. The system mainboard 210 operate as “head node” and the system mainboard 220 are “compute nodes” managed by the head node. The central management module 211 and the local cards 221 are linked through a management bus 230 for communication.

The system mainboard in the present invention operates as a computing sub-system. Generally, one or more CPU (Central Processing Unit, or simply “processor”) and system memories connected by system buses (all not shown) are essential for a system mainboard. Namely, in an embodiment of the present invention, the system mainboard may be implemented as a CPU card/board. For example, a HPC (High Performance Calculating) system like supercomputer may include several CPU boards operative as the system mainboards; other common system components may possibly be separated into another PCB (Printed Circuit Board) like backplane or function boards/cards. In some embodiment of the present invention, the system board may be a typical mother board, which usually has those implementation-independent system components such as North/South Bridge (or system chipset), one or more BIOS (Basic Input/Output System, or boot image embedded in a memory device), I/O controllers (like Super I/O controller) and I/O buses/connectors for connections.

The central management module 211 sends plural command signals to the system mainboards 220 and function modules 240 through the management bus 230, and receives plural status signals from the system mainboards and function modules 240 through the management bus 230. It basically includes a central BMC (not shown) that may be implemented as an on-board remote controller, or as a remote control unit operative on a remote management card (such as SMDC, Sever Management Daughter Card). In the present invention, the central BMC of the central management module 211 monitors/controls the component performance of the designed system mainboard(s) and various operation statuses thereof, such as temperatures, voltages, fan speeds, power supply states, bus errors, system physical security and etc. Through the management bus 230 and the local cards 221, the central management module 211 is capable of monitoring/controlling the system boards 220. The system board 210 itself and some system-level or chassis-level function modules 240 like power supply module 140, system fan module 150 and etc. may also be monitored/controlled by the central management module 211. In short, the BMC-based central management module 211 manages all the system mainboards 210, 220 and the function modules 240 in the multi-mainboard system 200.

In addition, to facilitate a remote management outside the chassis of the multi-mainboard system 200, the central BMC of the central management module 211 may be connected with a remote management host (not shown) through remote management link(s) (not shown). The remote management link may be compatible with IPMI (Intelligent Platform Management Interface) specification, such as the communication links through system I/O bus, network interface connection (network interface controller/connector/bus), Serial Port connection, and even SMBus (System Management Bus).

The management bus 230 in the embodiment may be various buses that have the same physical layer architecture as SMBus/I2C (Inter-Integrated Circuit) Bus, such as SMBus/I2C Bus itself, IPMB (Intelligent Platform Management Bus), or even ICMB (Intelligent Chassis Management Bus). In the present invention, the management bus sends command signals and status signals under IPMI between the central management module and the local cards (or management cards described below). Generally, the management bus may be implemented by communication cable(s) and/or PCB-type interconnection (such as backplane/mid-plane/side-plane) connected electrically between the central management module and the local card (or the management card).

The local card 221 mainly sends status signals from the system mainboard 220 and receives command signals from the central management module 211. Basically, the local card 221 needs a card interface (not shown) to communicate with the system board 220 and the management bus 230. Other circuits are also required for the local card 221 to enable basic card functions, and receive/send command or status signals from/to the system board 220 or the management bus 230.

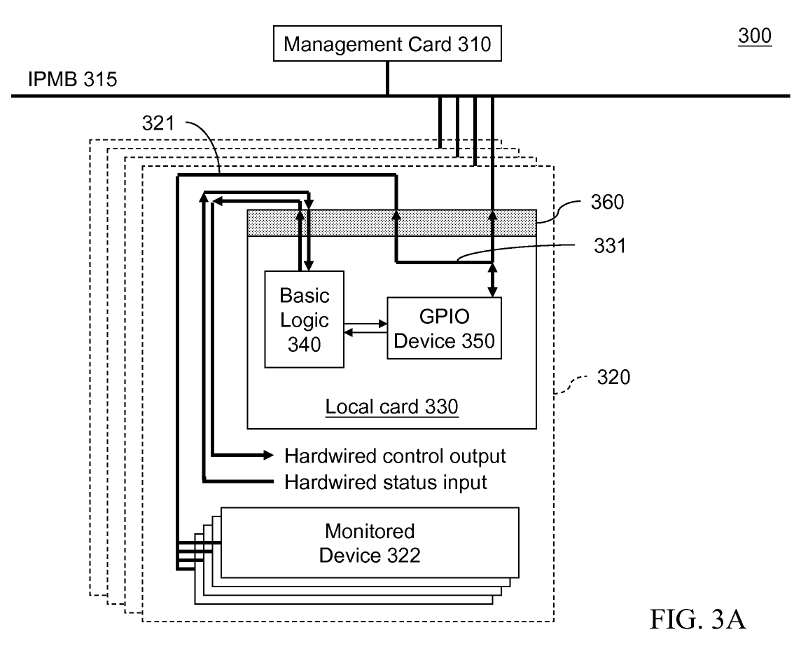

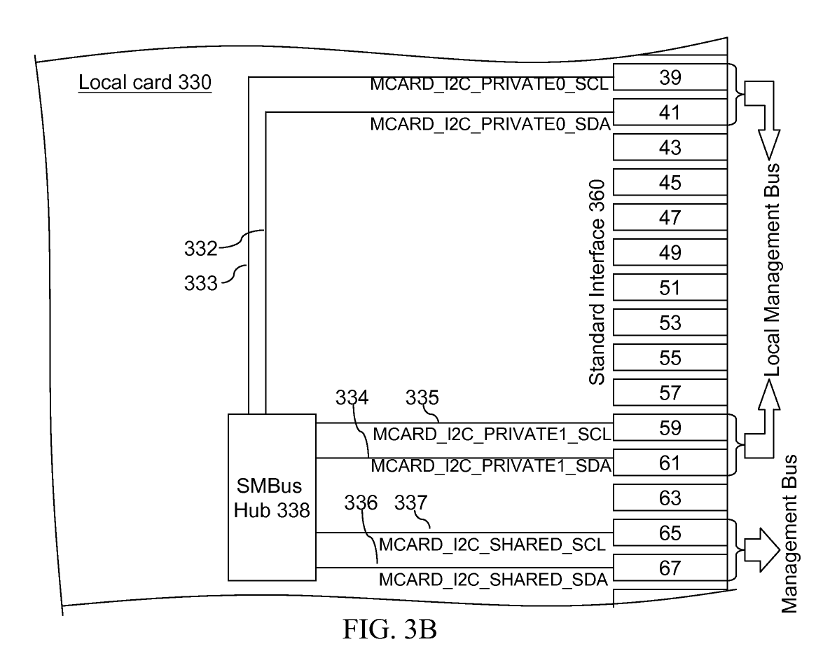

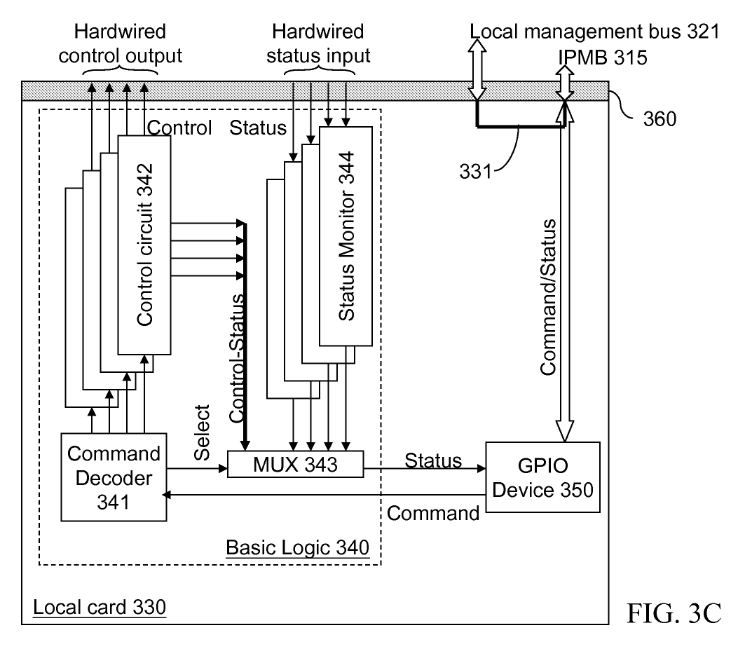

Please refer to FIG. 3A. In an embodiment of the present invention, system management architecture 300 includes a management card 310 and several local cards 330, all connected through an IPMB 315.

The management card 310 is BMC-based, performing the major management functions as a central management module (not shown). The management card 330 may be inserted into an IPMI-based slot (not shown) on any of the system boards 320 or on a backplane/mid-plane/side-plane or switch-board in a multi-mainboard system. Besides, the management card 310 may be connected with a remote host (not shown) for remote control.

The local cards 330 replace all the management cards (not shown) of the system mainboards 220. Each of the local cards 330 has a basic logic 340, a GPIO (General Purpose Input/Output) device 350 and a management interface 360. In the present invention, the local card and the replaced management card have the same management interface for a compatible replacement. The management interface 360 is a card interface compatible with IPMI specification, and may be inserted into an IPMI-based slot (not shown) on the system mainboard 320. Currently, interfaces that follow OPMA (Open Platform Management Architecture) specification (defined by Advanced Micro Devices, Inc.) or ASMI (Advanced System Management Interface) specification (defined by Intel Corporation) are applicable to realize the management interface 360.

The GPIO device 350 provides plural GPIO pins for receiving/sending the command/status signals between the basic logic 340 and the management bus (IPMB 315) through the management interface 360. Generally a GPIO expander is quite useful for the same purpose; some controller(s) with unused GPIO pins may be used as well. Through the management interface 360 and the IPMB 315, the GPIO device 350 may connect with the management card 310 receives and sends command signals to the basic logic 340. In the opposite, the GPIO device 350 also receives the statue signals from the basic logic 340 and sends through the management interface 360, the IPMB 315 to the management card 310.

The basic logic 340 processes the command/status signals and sends between the GPIO device 350 and the system mainboard 320 through the management interface 360. It mainly decodes the command signals from the management card 310, then generates and sends a hardwired control output through the management interface 360 to the system mainboard 320. The hardwired control output includes control signals for the purposes of status LED control, power/reset control, interrupt control and etc. Moreover, the basic logic 340 receives a hardwired status input from the system mainboard 320 and sends through the GPIO device 350, the management interface 360, the IPMB 315 to the management card 310. The hardwired status input may include various status signals from monitor circuits, sensors and etc. on the system mainboard 320.

In addition, one or more local management bus 321 on the system mainboard 320 and the IPMB 315 (the management bus) are connected through the management interface 360 of the local card 330. The local card 330 further includes a management path 331, which may includes electrical traces to connect the management bus (the IPMB 315) and the local management bus 321. Therefore, the central management module or the management card 310 may directly receive status signals from the monitored device(s) 322 through the local management bus 321 for monitoring. Similarly, the management card 310 may send command signals directly to control the monitored device(s) 322. In an embodiment, the local management bus 321 is compatible with IPMI or SMBus/I2C, and the monitored device(s) 322 controlled by the local management bus 321 may be certain sensors, memories and etc.

In FIG. 3B, a section of an OPMA-based management interface is disclosed. As defined in Open Platform Management Architecture Specification rev. 1.1 (“OPMA Spec.”, by Advanced Micro Devices, Inc.), the local card 330 uses 200 OPMA-pins as the management interface 360. Odd Pins 31˜67 are defined for SMBus/I2C interface. According to the pin assignments in the OPMA Spec., Pin 65 (MCARD_I2C_SHARED_SCL) and Pin 67 (MCARD_I2C_SHARED_SDA) may be used to connect the IPMI-based management bus (not shown); Pin 39 (MCARD_I2C_PRIVATE0_SCL), 41 (MCARD_I2C_PRIVATE0_SDA), 59 (MCARD_I2C_PRIVATE1_SCL) and Pin 61 (MCARD_I2C_PRIVATE1_SDA) may be connected to the IPMI-based or SMBus/ISC-based local management bus. Generally, Pin 39/41 (or Pin 59/61) and Pin 65/67 may be connected directly through electrical traces to form a simple management path (not shown). In FIG. 3B, the management path (not marked) further includes a SMBus hub 338 for multiple signal exchange between the electrical traces 332˜337. Pin 39/41 and 59/61 are connected to a SMBus hub 338 through electrical traces 332/333 and 334/335; Pin 65/67 is also connected to the SMBus hub 338 through electrical traces 336/337. Thus, the management path facilitates Pin 65/67 to communicate with Pin 39/41 or Pin 59/61 and built up a link between the management bus and the local management buses.

FIG. 3C discloses an example for the local card of the present invention. The basic logic 340 of the local card 330 includes a command decoder 341, plural control circuits 342, a multiplexer (MUX) 343 and plural status monitors 344.

The command decoder 341 decodes command signals and a selection signal sent originally from the central management module. These command signals and the selection signal are originally sent from the central management module or a remote host (both not shown). The decoded command signals are sent to the control circuits 342 to generate the hardwired control output with plural control signals. The decoded selection signal will be send to the multiplexer 343.

The status monitors 344 receive the hardwired status input from the system mainboard (not shown) to monitor designated system statuses, such as power status, button status and etc. Actually, the status monitor 344 also provides customization capability to monitor any specific status. Event monitors (not shown) may also be included in the basic logic 340. Extra customized status/event monitor(s) (not shown) may not be included in the basic logic 341; alternative locations will be on the local card 330 or the system mainboard 320. A CPLD (Complex Programmable Logic Device) may be used as a combination of status monitors and/or even event monitors. The status/event monitor may be realized by several flip-flops and logic gates.

The multiplexer 343 receives status signals from the status monitors 344 and control-status signals from the control circuits 342, and then selectively sends to the GPIO device 350 according to the decoded selection signal from the command decoder 341.

As to the actual implementation, the central management module will need the similar design as the local card for reducing firmware modifications if it is implemented as an independent PCB (interconnection plane or interposer card). Meanwhile, a management card may be used to perform the core functions of the central management module.

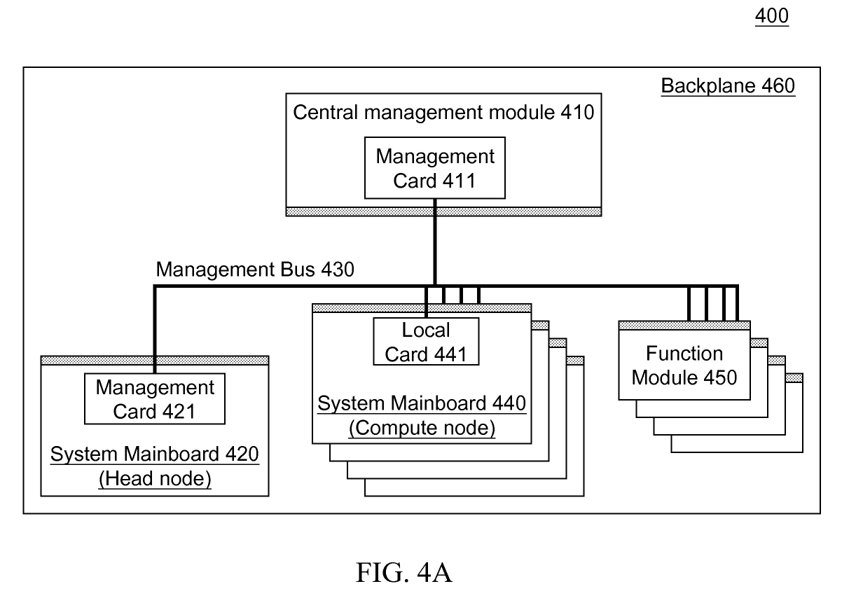

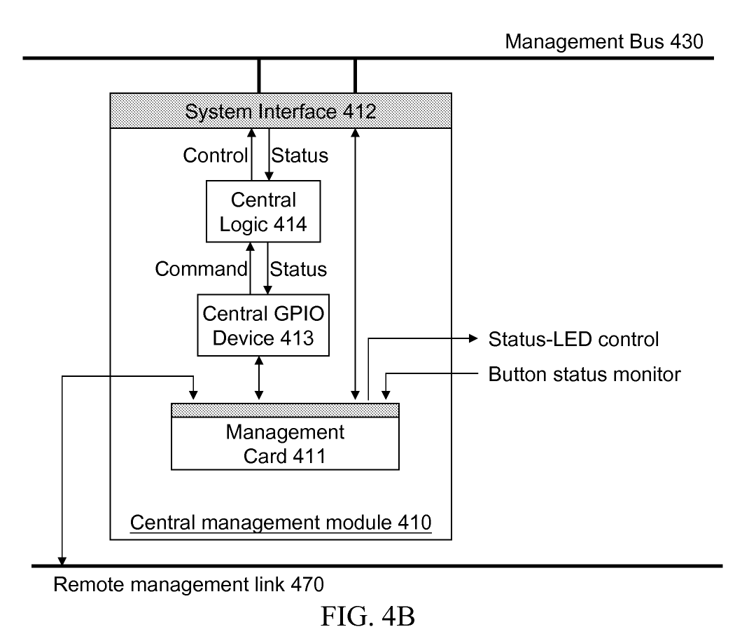

Please refer to FIG. 4A, a multi-mainboard 400 includes a central management module 410, a system mainboard 420 (head node), several system mainboards 440 (compute nodes) and several function modules 450, all configured on a backplane 460 through system interfaces (each part marked in gray).

The central management module 410 and the system mainboard 420 use management cards 411, 421 respectively. On the contrary, the management cards (removed) on the system mainboards 440 have been replaced by the local cards 441. Each of the system mainboards 420, 440 has a same IPMI-based slot (not shown) for the management card 421 or the local cards 441; provided that each of the management card 421 and the local cards 441 has a management interface (not shown) as the card interface. The central management module 410 connects the management card 421 and the local cards 441 through a management bus 430.

To achieve minimum firmware differences between the central management module 410 and the local card 441, both must have similar hardware architecture. The local card 441 may use the design mentioned above; but the central management module 410 needs some modifications.

Please refer to FIG. 4B. As an interposer card architecture, the central management module 410 has a system interface 421 inserted onto the backplane 460 (FIG. 4A) of the multi-mainboard system 400. The central management module 410 also includes a management card 411, a central GPIO device and a central logic 414. The system interface 421 may be any type/specification of card-board or board-board interconnection. In actual implementation, the central management module 410 may be configured as an on-board module of the backplane 460. If so, the system interface 412 is not essential for the central management module 410.

The BMC-based management card 411 inserted onto the central management module 410 is used to perform internal control/monitor and provide external management capability to a remote host (not shown). The management card 411 may connect with the management bus 430 directly through on-card path (electrical traces or circuits) and the system interface 412, or indirectly through the central GPIO device 413, the central logic 414 and the system interface 412. Therefore, the management card 411 is capable of sending command/control signals to the management card 421, the local cards 441 and the function modules 450 in FIG. 4A. And meanwhile, status signals from the system mainboards 420, 440 and the function modules 450 may be sent to the management card 411 of the central management module 410.

The central GPIO device 413 connected between the management card 411 and the central logic 414 provides plural GPIO pins to allow multiple input signals and limited output signals. Generally a GPIO expander is quite useful for the same purpose; some controller(s) with unused GPIO pins may be used as well. The central GPIO device 413 basically has the same design and functions with the GPIO device of the local card, as disclosed in former embodiment(s).

The central logic 414 mainly decodes the command signals from the management card 411, then generates and sends control signals through the system interface 412 to the system mainboards 420, 440 and/or the function modules 450. Also, the central logic 414 receives status signals from the system mainboards 420, 440, the function modules 450 or other devices on the backplane 460. The central logic 414 may include similar essential components like the basic logic of the local card, as disclosed in the former embodiments. For example, the central logic 414 may include a command decoder, plural control circuits and a multiplexer (all not shown). Plural customized status/event monitors (not shown) may be options for the central logic 414 or the management card 411 of the central management module 410.

Except the system interface 412, the central management module 410 may include other card-type interface or even cables for different purposes. For instance, the management card 411 may be connected to a remote management link 470 to communicate with a remote host (not shown). In addition, the management card 411 may also be connected to control system-level or chassis-level functions, such as status-LED control or button-status monitor.

In short, the central management module is BMC-based. It may include an on-board BMC thereon, or a BMC-based management card for sending the command signals and receiving the status signals. The central management module may further include a central GPIO device and a central logic. The central GPIO device provides a plurality of GPIO pins for receiving/sending the command/status signals between the management card and the central logic; the central logic processes the command/status signals and sending between the central GPIO device and the management bus. A card-type or board-type central management module may further include a system interface for connecting with the management bus on another interconnection plane.

As to the detailed combination of the central logic, it may include the following components: a command decoder for decoding the command signals and a selection signal sent originally from the management card of the central management module; status/event monitor(s) for receiving the status signals from the system mainboard through the management bus and the local card; control circuit(s) for generating at lest one control signal and at least one control-status signal according to the decoded command signal, the control signals being sent to the system mainboard through the management bus and the local card; and a multiplexer for receiving the control-status signal and the status signals and selectively sending to the GPIO device according to the decoded selection signal.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A system management architecture for monitoring and controlling at least one system mainboard, comprising:
a management bus;
a central management module sending a plurality of command signals to the system mainboard through the management bus, and receiving a plurality of status signals from the system mainboard through the management bus; and
an local card or a BMC (Baseboard Management Controller)-based management card alternatively configured on the system mainboard, each having a same management interface for connecting with the system mainboard and the management bus.

2. The system management architecture of claim 1, wherein the local card comprises a GPIO (General Purpose Input/Output) device and a basic logic, the GPIO device providing a plurality of GPIO pins for receiving/sending the command/status signals between the basic logic and the management bus through the management interface, and the basic logic processing the command/status signals and sending between the GPIO device and the system mainboard through the management interface.

3. The system management architecture of claim 2, wherein the basic logic comprises:
a command decoder for decoding the command signals and a selection signal sent originally from the central management module;
at least one status monitor or event monitor receiving the status signals from the system mainboard through the management interface;
at least one control circuit generating at least one control signal and at least one control-status signal according to the decoded command signal, the control signals being sent to the system mainboard; and
a multiplexer receiving the control-status signal and the status signals and selectively sending to the GPIO device according to the decoded selection signal.

4. The system management architecture of claim 3, wherein the local card further comprises a management path for connecting with a local management bus of the system mainboard and the management bus through the management interface, thereby directly controlling at least one monitored device on the system mainboard.

5. The system management architecture of claim 1, wherein the central management module is BMC-based.

6. The system management architecture of claim 1, wherein the central management module comprises another BMC-based management card for sending the command signals and receiving the status signals.

7. The system management architecture of claim 6, wherein the central management module further comprises a central GPIO device and a central logic, the central GPIO device providing a plurality of GPIO pins for receiving/sending the command/status signals between the management card and the central logic, and the central logic processing the command/status signals and sending between the central GPIO device and the management bus.

8. The system management architecture of claim 7, wherein the central logic comprises:
a command decoder for decoding the command signals and a selection signal sent originally from the management card of the central management module;
at least one status monitor or event monitor receiving the status signals from the system mainboard through the management bus and the local card;
at least one control circuit generating at lest one control signal and at least one control-status signal according to the decoded command signal, the control signals being sent to the system mainboard through the management bus and the local card; and
a multiplexer receiving the control-status signal and the status signals and selectively sending to the GPIO device according to the decoded selection signal.

9. The system management architecture of claim 7, wherein the central management module further comprises a system interface for connecting with the management bus.

10. The system management architecture of claim 1, wherein the management interface is compatible with IPMI, OPMA (Open Platform Management Architecture) or ASMI (Advanced System Management Interface) specification.

11. The system management architecture of claim 1, wherein the management bus is compatible with SMBus/I2C Bus, IPMB (Intelligent Platform Management Bus) or ICMB (Intelligent Chassis Management Bus).

12. A local card for alternatively replacing a BMC-based management card to be configured on at least one system mainboard through a management interface and controlled/monitored through a management bus, wherein the local card comprises a GPIO device and a basic logic, the GPIO device providing a plurality of GPIO pins for receiving/sending the command/status signals between the basic logic and the management bus through the management interface, and the basic logic processing the command/status signals and sending between the GPIO device and the system mainboard through the management interface.

13. The local card of claim 12, wherein the basic logic comprises:
a command decoder for decoding a plurality of command signals and a selection signal sent from the management bus;
at least one status monitor or event monitor receiving a plurality of status/event signals from the system mainboard through the management interface;
at least one control circuit generating at least one control signal and at least one control-status signal according to the decoded command signal, the control signals being sent to the system mainboard; and
a multiplexer receiving the control-status signal and the status signals and selectively sending to the GPIO device according to the decoded selection signal.

14. The local card of claim 12, wherein the local card further comprises a management path for connecting with a local management bus of the system mainboard and the management bus through the management interface, thereby directly controlling at least one monitored device on the system mainboard.

15. The local card of claim 14, wherein the local management bus is compatible with IPMI (Intelligent Platform Management Interface) or SMBus (System Management Bus)/I2C (Inter-Integrated Circuit) Bus and the monitored devices may be certain sensors or memories.

16. The local card of claim 14, wherein the management path includes a plurality of electrical traces.

17. The local card of claim 16, wherein the management path further includes a SMBus hub for multiple signal exchange between the electrical traces.

18. A central management module for sending a plurality of command signals to at least one system mainboard through a management bus, and receiving a plurality of status/event signals from the system mainboard through the management bus;
wherein the central management module comprises a BMC-based management card for sending the command signals and receiving the status signals;
wherein the central management module further comprises a central GPIO device and a central logic, the central GPIO device providing a plurality of GPIO pins for receiving/sending the command/status signals between the management card and the central logic, and the central logic processing the command/status signals and sending between the central GPIO device and the management bus.

19. The central management module of claim 18, wherein the central logic comprises:
a command decoder for decoding the command signals and a selection signal sent originally from the management card of the central management module;
at least one status monitor or event monitor receiving the status/event signals from the system mainboard through the management bus and the local card;
at least one control circuit generating at lest one control signal and at least one control-status signal according to the decoded command signal, the control signals being sent to the system mainboard through the management bus and the local card; and
a multiplexer receiving the control-status signal and the status signals and selectively sending to the GPIO device according to the decoded selection signal.

20. The central management module of claim 18, wherein the central management module further comprises a system interface for connecting with the management bus.
